(19) United States
(12) Patent Application Publication
(10) Pub. No.: US 2012/0106670 A1
(43) Pub. Date: May 3, 2012

(54) METHOD, SERVER AND CUSTOMER TERMINAL FOR DIGITAL CONTENT TRANSMISSION

(75) Inventors: KUAN-HONG HSIEH, Tu-Cheng (TW); HAN-CHE WANG, Tu-Cheng (TW); CHIH-SAN CHIANG, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/105,882

(22) Filed: May 11, 2011

(30) Foreign Application Priority Data
Oct. 28, 2010 (CN) 201010523104.2

(51) Int. Cl. H04L 27/00

(52) U.S. Cl. 375/295

(57) ABSTRACT

A server is provided. The serve includes a publishing module, a program module, a relationship module, and a transmission module. The publishing module publishes digital content. The program module stores programs for playing the digital content. The relationship module stores a relationship between the digital content, a plurality of pre-stored hardware information of customer terminals, and programs for playing corresponding the digital contents corresponding to hardware information. The transmission module searches a particular one of the programs for playing a particular one of the digital contents in response to a request from a customer terminal for downloading the particular digital content. The particular program is corresponding to the hardware information of the customer terminal according to the pre-stored hardware information. The transmission module further transmits the particular digital content and the particular program to the customer terminal A customer terminal and a digital content transmission method are also provided.

### BACKGROUND

1. Technical Field

The present disclosure relates to digital content transmission, particularly to a digital content transmission method, a server and a customer terminal for digital content transmission.

2. Description of Related Art

As more and more digital contents are published on the internet. Software has to be downloaded to play this digital content, which is inconvenient to users.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of a digital content transmission system, according to an exemplary embodiment.

FIG. 2 is a flowchart of transmitting a digital content implemented by the digital content transmission system of FIG. 1.

### DETAILED DESCRIPTION

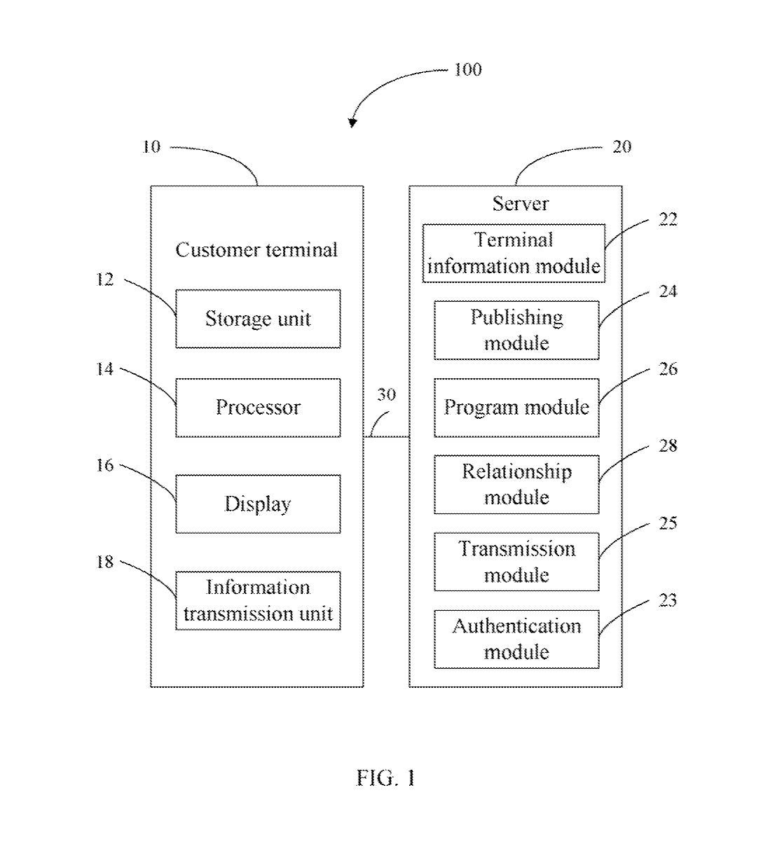

Referring to FIG. 1, a digital content transmission system 100 according to an exemplary embodiment includes a customer terminal 10, a server 20 and a network 30. The customer terminal 10 communicates with the server 20 through the network 30.

The customer terminal 10 includes a storage unit 12, a processor 14, a display 16, and an information transmission unit 18. The storage unit 12 stores information of the customer terminal 10. The information of the customer terminal 10 includes user information and hardware information of the customer terminal 10. The user information includes a user name and a user password. The hardware information of the customer terminal 10 includes a model of the processor 14 and a resolution of the display 16. The information transmission unit 18 is used for transmitting the information of the customer terminal 10 from the storage unit 12 to the server 20 through the network 3, when the customer terminal 10 sends a request for downloading digital content to the server 20.

The server 20 is used for providing digital content to be downloaded by users. The server 20 includes a terminal information module 22, a publishing module 24, a program module 26, a relationship module 28, a transmission module 25 and an authentication module 23. The terminal information module 22 is used for receiving and storing the information of the customer terminals. The publishing module 24 is used for publishing digital contents. The program module 26 is used for storing programs for playing corresponding digital contents. The relationship module 28 is used for storing a table defining a relationship of the digital contents, a number of pre-stored hardware information, and programs for playing corresponding digital content. The authentication module 23 is used for storing pre-stored user information and determining whether a customer terminal 10 is authorized based on the information provided by the customer terminal 10 and the pre-stored user information if a digital content requested by the customer terminal 10 is encrypted. The transmission module 25 is used for searching a program for playing the digital content in the program module 26 corresponding to the hardware information from the customer terminal 10 according to the relationship recorded by the relationship module 28, and then transmitting the digital content and the program together to the customer terminal 10.

When the customer terminal 10 sends a request to the server 20 to download a unencrypted digital content, the information transmission unit 18 sends the information of the customer terminal 10 from the storage unit 12 to the server 20. The information receiving module 21 receives the information of the customer terminal 10. The transmission module 25 searches a program for playing the digital content in the program module 26 corresponding to the hardware information of the customer terminal 10 according to the relationship recorded by the relationship module 28, and then transmits the digital content and the program together to the customer terminal 10. The information transmission unit 18 receives the digital content and the program, and plays the digital content using the program.

When the customer terminal 10 sends a request to the server 20 to download an encrypted digital content, the information transmission unit 18 sends the information of the customer terminal 10 to the server 20. The information receiving module 21 receives the information of the customer terminal 10. The authentication module 25 compares the user information of the customer terminal 10 with the pre-stored user information to determine whether the customer terminal is authorized. If the customer terminal is authorized, the transmission module 25 searches a program for playing the digital content in the program module 26 corresponding to the hardware information of the customer terminal 10 according to the relationship recording in the relationship module 28, and transmits the digital content and the program together to the customer terminal 10. The information transmission unit 18 receives the digital content and the program, and plays the digital content using the program. If the customer terminal is unauthorized, the server 20 rejects the request for downloading the encrypted digital content.

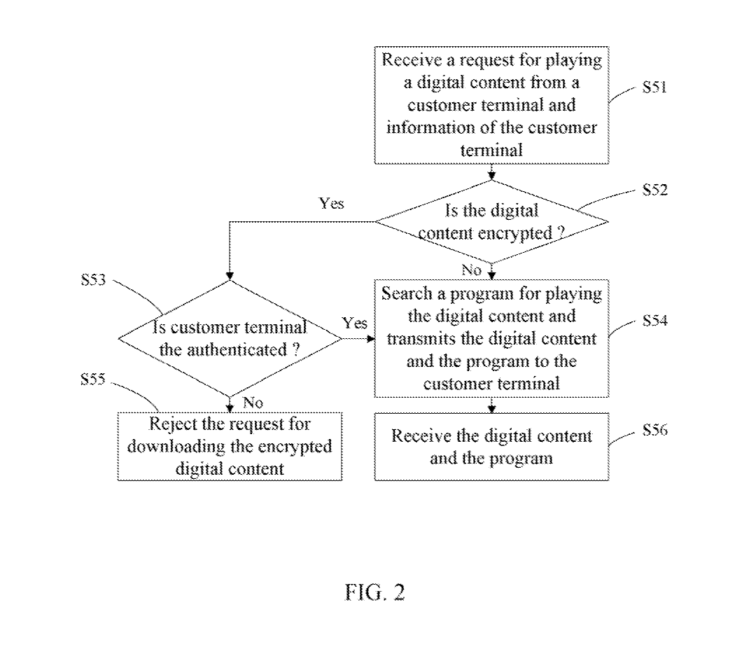

Referring to FIG. 2, a flowchart of transmitting a digital content is provided.

In step S51, a server 20 receives a request for playing a digital content from a customer terminal and information of the customer terminal 10. The customer terminal 10 includes an information transmission unit 18. The information transmission unit 18 is used for transmitting the information of the customer terminal 10 to the server 20 through a network 30 when the customer terminal 10 sends a request for downloading the digital content. The information of the customer terminal 10 includes user information and hardware information. The user information includes a user name and a user password. The hardware information of the customer terminal 10 includes a model of a processor and a resolution of a display of the customer terminal 10. The server 20 includes a terminal information module 22, a program module 26, a relationship module 28, a transmission module 25 and an authentication module 23. The terminal information module 22 is used for receiving and storing information of customer terminals. The program module 26 is used for storing programs for playing corresponding digital content. The relationship module 28 is used for storing a table defining a relationship of the digital content, a number of pre-stored hardware information, and programs for playing corresponding digital content. The authentication module 23 is used for storing pre-stored user information and determining whether a customer terminal 10 is authorized based on the information provided by the customer terminal 10 and the pre-stored user information if digital content requested by the customer terminal 10 is encrypted.

In step S52, the server 20 determines whether the digital content is encrypted. If the digital content is encrypted, the procedure goes to step S53, otherwise the procedure goes to step S54.

In step S53, the authentication module 25 compares the information of the customer terminal 10 with the pre-stored user information in the authentication module 23 to determine whether the customer terminal 10 is authorized. If the customer terminal 10 is authorized, the procedure goes to step S54, otherwise the procedure goes to step S55.

In step S54, the transmission module 25 searches a program for playing the digital content in the program module 26 corresponding to the hardware information of the customer terminal 10 according to the relationship recording in the relationship module 28, and then transmits the digital content and the program together to the customer terminal 10.

In step S55, the server 20 rejects the request for downloading the encrypted digital content.

In step S56, the information transmission unit 18 receives the digital content and the program, and then the user can play the digital content using the program.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A server for digital content transmission, comprising:
a publishing module configured for publishing digital contents;
a program module configured for storing programs for playing the digital contents;
a relationship module configured for storing a relationship between the digital contents, a plurality of pre-stored hardware information of customer terminals, and programs for playing the digital contents corresponding to hardware information; and
a transmission module configured for searching a particular one of the programs for playing a particular one of the digital contents in the program module in response to a request from a customer terminal for downloading the particular digital content, the particular program corresponding to the hardware information of the customer terminal according to the pre-stored hardware information in the relationship stored in the relationship module, and transmitting the particular digital content and the particular program to the customer terminal.

2. The server as described in claim 1, further comprising a terminal information module configured for receiving and storing the information of the customer terminal.

3. The server as described in claim 1, further comprising an authentication module, wherein the authentication module is configured for determining whether the customer terminal is authorized, the transmission module searches the program for playing the digital content when the customer terminal is determined to be authorized.

4. A customer terminal comprising:
a storage unit configured for storing information of the customer terminal; and
an information transmission unit configured for transmitting the information of the customer terminal to a server through a network to send a request of playing a digital content to the server, and receiving a program corresponding to both hardware information of the customer terminal and the digital content from the server.

5. The customer terminal as described in claim 4, wherein the hardware information comprises a model of a processor of the customer terminal and a resolution of a display of the customer terminal.

6. A digital content transmission method, comprising:
receiving a request from a customer terminal for playing a particular one of digital contents and information of the customer terminal;
determining whether the particular digital content is encrypted;
searching a particular one of programs for playing the particular digital content corresponding to hardware information of the customer terminal; and
transmitting the particular digital content and the particular program together to the customer terminal if the digital content is unencrypted.

7. The digital content transmission method as described in claim 6, wherein if the digital content is encrypted, further comprising:
determining whether the customer terminal is authorized according to user information of the customer terminal;
if the customer terminal is authorized, searching the particular program for playing the digital content according to the hardware information of the customer terminal and transmitting the particular program to the customer terminal if the digital content is unencrypted; and
if the customer terminal is unauthorized, rejecting transmitting the digital content.

8. The digital content transmission method as described in claim 6, wherein the hardware information comprises a model of a processor of the customer terminal and a resolution of a display of the customer terminal.

9. The digital content transmission method as described in claim 7, wherein the user information comprises a user name and a user password.
